(19) United States
(12) Patent Application Publication
(10) Pub. No.: US 2026/0346910 A1
(43) Pub. Date: Nov. 5, 2026

(54) METHODS AND APPARATUS FOR A STEER-BY-WIRE STEERING SYSTEM

(71) Applicant: Ford Global Technologies, LLC, Dearborn, MI (US)

(72) Inventors: Alexander Ein Waldt, Köln (DE); Goetz-Philipp Wegner, Dortmund (DE); Sergio Codonesu, Aachen (DE); Gerhard Friederich, Bornheim (DE); Oliver Nehls, Düsseldorf (DE)

(21) Appl. No.: 19/661,264

(22) Filed: Apr. 28, 2026

(30) Foreign Application Priority Data
May 5, 2025 (DE) 102025117088.6

(51) Int. Cl. B62D 6/00; B62D 15/02

(52) U.S. Cl. CPC B62D 6/00; B62D 15/021

(57) ABSTRACT

The disclosure generally relates to vehicles, and more particularly, to methods and apparatus for a steer-by-wire (SBW) steering system. An example steer-by-wire (SBW) steering system comprises a front-wheel steering system, a rear-wheel steering system, and a controller configurable to detect an unexpected operating condition of the rear-wheel steering system, determine a wheel angle associated with the unexpected operating condition, and generate a control signal to cause a road wheel actuator of the front-wheel steering system to steer road wheels coupled to the front-wheel steering system based on the unexpected operating condition and the wheel angle.

### RELATED APPLICATION

This patent claims priority from DE Patent Application Number 102025117088.6, which was filed on May 5, 2025, and is hereby incorporated by reference in its entirety.

### FIELD OF THE DISCLOSURE

The disclosure generally relates to vehicles, and more particularly, to methods and apparatus for a steer-by-wire (SBW) steering system.

### BACKGROUND

Conventional vehicle steering systems rely on mechanical linkages between the steering input device and the road wheels, which can introduce packaging constraints, added weight, and limitations in tuning steering characteristics. Steer-by-wire systems replace such mechanical connections with electronic sensing and actuation, enabling greater flexibility in control and improved integration with driver assistance systems.

### SUMMARY

An example steer-by-wire (SBW) steering system comprises a front-wheel steering system, a rear-wheel steering system, and a controller configurable to detect an unexpected operating condition of the rear-wheel steering system, determine a wheel angle associated with the unexpected operating condition, and generate a control signal to cause a road wheel actuator of the front-wheel steering system to steer road wheels coupled to the front-wheel steering system based on the unexpected operating condition and the wheel angle.

An example vehicle comprises a steer-by-wire (SBW) steering system including a front-wheel steering system and a rear-wheel steering system, first road wheels coupled to the front-wheel steering system and second road wheels coupled to the rear-wheel steering system, and controller circuitry to execute machine readable instructions to detect an unexpected operating condition of the rear-wheel steering system, determine a wheel angle of the second road wheels associated with the unexpected operating condition, and generate a control signal to cause the front-wheel steering system to steer the first road wheels based on the unexpected operating condition and the wheel angle.

An example non-transitory computer readable storage medium comprises instructions to cause at least one programmable circuitry to detect an unexpected operating condition of a rear-wheel steering system, determine a wheel angle associated with the unexpected operating condition, and generate a control signal to cause a front-wheel steering system to steer road wheels coupled to the front-wheel steering system based on the unexpected operating condition and the wheel angle.

### BRIEF DESCRIPTION OF DRAWINGS

FIG. 1 is a schematic representation of a vehicle including a SBW steering system in accordance with examples disclosed herein.

FIG. 2 is a flowchart representative of example machine readable instructions and/or example operations that may be executed, instantiated, and/or performed by example programmable circuitry to implement the SBW steering system of FIG. 1.

FIGS. 3A and 3B are schematic representations of a vehicle in accordance with the flowchart of FIG. 2.

FIGS. 4A and 4B are schematic representations of a vehicle in accordance with the flowchart of FIG. 2.

FIG. 5 is a block diagram of an example processing platform including programmable circuitry structured to execute, instantiate, and/or perform the example machine readable instructions and/or perform the example operations of FIG. 2 to implement the SBW steering system of FIG. 1.

In general, the same reference numbers will be used throughout the drawing(s) and accompanying written description to refer to the same or like parts. The figures are not necessarily to scale.

### DETAILED DESCRIPTION

In examples disclosed herein, unexpected operating condition, limited operating condition, unexpected operating state, and limited operating state may be used interchangeably to refer to a condition or a state of a component that is unavailable, inoperable, and/or operating outside of an operating input performance range of the component.

Modern vehicles can feature a combination of front-wheel steering and rear-wheel steering. The front-wheel steering can be implemented by a traditional steering system with an additional angle overlay system as well as by a steer-by-wire steering system.

An unexpected operating condition in rear-wheel steering can lead to unintentional self-steering and/or a frozen (e.g., locked) rear steering angle. Typically, if there is an unexpected operating condition that results in a locked rear wheel angle, the rear wheel steering will turn off at the actual position of the road wheel angle at the time the unexpected operating condition occurred.

In some known rear-wheel steering systems, the actuator is not configured redundantly, so the permissible rear wheel angles must be limited to smaller values while driving at higher speeds. This generally ensures lateral guidance in the event of unexpected operating conditions.

In conventional steering systems, an unintentional constant locked rear wheel angle leads to an unintentional yaw of the vehicle. The self-aligning forces of the front tires and suspension guide the driver to the appropriate steering wheel angle relative to the inoperable rear wheel angle through the steering wheel torque due to the self-aligning forces. The residual yaw error due to the unintentional rear wheel angle error and the vehicle reaction due to the self-aligning forces must be sufficiently controlled by the driver. This means that the driver must apply a steering wheel angle of non-zero degrees to drive straight ahead. In this steering wheel position, the vehicle goes straight ahead and the steering wheel torque is almost zero. This steering wheel displacement, caused by the static inoperable rear wheel angle, must be controllable for the remaining driving cycle.

With a steer-by-wire steering system, the self-aligning forces may not be present or may only be present to a lesser extent in the feedback torque due to the mechanically separated steering wheels and wheels. In the event of an unexpected operating condition, this leads to limited guidance for the driver at the steering wheel. This reduces the controllability of the vehicle with the same extent of the inoperable rear wheel angle. This effect also means that when driving in a straight line, with a steering wheel offset as described above, the driver must maintain his intended steering wheel angle against a higher steering wheel torque compared to conventional steering systems. This is uncomfortable for the driver.

Furthermore, rear-wheel steering can, among other things, enable speed-dependent tuning of the yaw reaction of the vehicle. This usually means that with the same steering wheel angle, the vehicle will yaw more at low vehicle speeds than at higher vehicle speeds. The dynamics of the vehicle's behavior are roughly equivalent to those of a variable steering ratio in a steer-by-wire steering system. In such examples, if the rear-wheel steering is inoperable and locks, as described earlier, the vehicle's steering behavior will change, resulting in less dynamic vehicle behavior at low vehicle speeds and more dynamic vehicle behavior at higher vehicle speeds, which further reduces the comfort for the driver.

Examples described herein enable vehicle control via lateral guidance in the event of an unexpected operating condition in a vehicle including rear-wheel steering. According to one aspect, vehicle control via lateral guidance in the event of the unexpected operating condition is enabled by a method for operating a steer-by-wire steering system (hereinafter referred to as the SBW steering system) for a vehicle. The SBW steering system includes at least a front-wheel steering system, a rear-wheel steering system, and a control device coupled with the front-wheel steering system and the rear-wheel steering system. The front-wheel steering system is configured to vary a first wheel angle of a steerable front wheel of the vehicle. The rear-wheel steering system is configured to vary a second wheel angle of a steerable rear wheel of the vehicle. The method includes at least the following operations. First, an unexpected operating condition of the rear-wheel steering system is received or detected by the control device. An inoperable wheel angle of a steerable rear wheel of the vehicle is received or determined by the control device. A compensatory measure is triggered by the control device in such a way that a yaw rate (also known as yaw moment) of the vehicle around a vehicle vertical axis caused by the inoperable wheel angle of the vehicle's steerable rear wheel is at least partially compensated, based on an adjusted control signal generated by the control device.

The disclosure is based on the finding that the effects of the unexpected operating condition of the rear-wheel steering system can be captured and used to trigger compensation measures with regard to the front wheel steering system, which can compensate for or at least mitigate the instabilities of the vehicle's lateral control caused by the unexpected operating condition. To do this, the control signal generated to the front-wheel steering system is influenced so that the yaw rate of the vehicle caused by the unexpected operating condition is reduced. This results in less vehicle movement involving less rotation around the vehicle's vertical axis. In addition, the feedback torque for the driver at the steering wheel can be adjusted to reduce yaw disturbance. In other words, compensating for an unexpected operating condition of the rear-wheel steering system achieves increased driving stability by effectively compensating for or reducing yaw rates caused by the unexpected operating condition. As a result, the vehicle is easier to steer by the driver in terms of lateral guidance, which increases comfort for the driver. The adapted control signal can therefore also generally ensure that the steering wheel does not diverge from the center position when driving in a straight line, which makes the lateral control of the vehicle particularly intuitive, even though the rear-wheel steering has an unexpected operating condition. In addition, the feedback torque on the steering wheel corresponds to the normal operating condition, as the adjusted control signal is considered by the control device without necessarily having to vary the dynamics on the steering wheel.

The unexpected operating condition of the rear-wheel steering system may include, for example, unintentional self-steering, loss of power, loss of steering function, loss of communication with the control device, or combinations thereof. All of these unexpected operating conditions can cause the rear-wheel steering to have a specific static or dynamic inoperable wheel angle compared to a steering input, causing a yaw rate that diverges from the yaw rate according to the steering input.

A static inoperable wheel angle is an inoperable wheel angle that has a constant offset over several control intervals relative to a target angle of the rear-wheel steering based on a steering input of the SBW steering system, for example, a rear-wheel steering system steering angle that locks after an unexpected operating condition.

A dynamic inoperable wheel angle is an inoperable wheel angle that has an offset that varies over several control intervals relative to a target angle of the rear-wheel steering system based on a steering input of the SBW steering system, for example, an unintentional self-steering of the rear-wheel steering system.

In some examples, the adjusted control signal generated by the control device can have a static offset for several consecutive control intervals of the control device, provided that the inoperable wheel angle of the steerable rear wheel is static. The static offset allows the vehicle to be moved straight ahead while the steering wheel is still in the middle, according to a straight alignment of the steering input. In such examples, the unexpected operating condition can only lead to a misalignment of the vehicle body according to the inoperable wheel angle of the steerable rear wheel. The vehicle body is then twisted in relation to the straight alignment. The onward journey remains more comfortable, as the feedback torque at the steering wheel is similar to the feedback torque behavior without unexpected operating conditions.

Alternatively or additionally, the adjusted control signal generated by the control device can have a dynamically varying offset for several control intervals of the control device, provided that the inoperable wheel angle of the steerable rear wheel varies depending on the control interval of the control device. This means that the driver can be provided with increased comfort in terms of lateral control of the vehicle at the steering wheel, even with dynamically varying characteristics of the rear-wheel steering.

The compensation of the control device by the dynamic offset allows larger inoperable wheel angles of the steerable rear wheels compared to a scenario without compensation. Therefore, in such examples, longer defect detection and processing times can generally be applied, which, for example, allows the inoperable wheel angle to be detected and the compensation measure to be adjusted. As a result, the application space for compensating for inoperable wheel angles is increased by appropriately adapted control signals.

Alternatively or additionally, the adjusted control signal generated by the control device can also be based on an adapted variable steering ratio of the SBW steering system. The adapted variable steering ratio can be generated, for example, by applying an alternative parameter curve of the steering ratio. The variable steering ratio also allows the feedback torque on the steering wheel to be adjusted for other parameters.

In some examples, in the normal mode of the SBW steering system, the control device issues control signals to the front-wheel steering system based on a steering input corresponding to a wheel angle input of at least one steerable front wheel. The control signals are based on a steering ratio of the normal operating mode. The adapted control signal has the static or dynamic offset per control interval of the control device compared to the control signal of the normal operating mode, and/or is based on the adapted variable steering ratio. As a result, the steering behavior of the SBW steering system is used as a reference for the adapted control signal in the event of an unexpected operating condition of the rear-wheel steering system. This enables the control device to adapt the behavior of the vehicle's lateral guidance to the steering behavior of the normal operating mode, so that the driver's steering behavior is almost the same as in normal operating mode, even in the event of an unexpected operating condition.

In some examples, the dynamic offset of a control interval of the control device is based on the inoperable wheel angle of the steerable rear wheel of the vehicle determined or received for this control interval. This means that the inoperable wheel angle is redetermined for each control interval. This means that dynamic changes in the inoperable wheel angle can also be considered, for example regarding an unexpected operating condition of the rear-wheel steering system, which can have a varying effect over time. A dynamic offset, which is based on the current inoperable wheel angle in real time, generally ensures effective and continuous stabilization of the vehicle even in the event of strongly fluctuating unexpected operating conditions of the rear-wheel steering system.

In some examples, the adapted variable steering ratio depends on the speed of the vehicle. The adapted variable steering ratio, which is based on the vehicle's speed, generally ensures optimized steering force and steering precision in different driving situations, such as in city traffic or on the motorway. In some examples, the vehicle's adapted variable steering ratio for low speeds can increase maneuverability in tight areas. Low vehicle speeds are speeds that are less than an initial speed threshold. For example, maneuverability may be more direct for such speeds than for vehicle speeds greater than the first speed threshold. A less direct ratio at higher speeds increases stability and thus creates balanced steering behavior.

In some examples, in the normal mode of the SBW steering system, the control device can output control signals to the rear-wheel steering system based on a steering input corresponding to a wheel angle input of at least one steerable rear wheel. The control signals are based on the steering ratio of the normal operating mode. The adjusted control signal issued for the front-wheel steering system is also based, at least proportionately, on the wheel angle input of at least one steerable rear wheel determined for this control interval. This means that the rear wheel angle intended is fully or partially considered with regard to the control of the steerable front wheel in accordance with the wheel angle input for the specific driving situation. This achieves a similar dynamic of the lateral guidance of the vehicle. In other words, because the adjusted front wheel control signal is also based, at least in part, on the rear wheel's wheel angle input for normal operating mode, harmonized overall steering is achieved that generally ensures smooth vehicle dynamics.

In some examples, the vehicle has a speed sensor that is configured to detect a speed of the vehicle and transmit it to the control device. The integration of a speed sensor allows the compensation measures to be adapted to specific situations and thus promotes precise control at varying driving speeds. For example, the speed of the vehicle can be considered regarding the variable steering ratio. In some examples, the speed sensor can detect rotation rates of the vehicle's road wheels around the axis of rotation and transmit them to the control device. The speed sensor itself or the control device can determine the speed of the vehicle based on the detected yaw rates.

In some examples, a wheel angle sensor can be coupled with at least one steerable rear wheel of the vehicle. The wheel angle sensor is configured to detect a wheel angle of the steerable rear wheel and transmit it to the control device. A wheel angle sensor for the rear wheel enables an exact determination of divergences from a target angle that the corresponding rear wheel should have. This leads to reliable detection and enables effective correction of the inoperable wheel angle.

In one aspect, the vehicle can include a yaw rate sensor. The yaw rate sensor can be configured to detect a yaw rate of the vehicle around a vehicle vertical axis and transmit it to the control device. The recorded yaw rate can be used to adjust the compensation measure to an erroneous yaw rate, which diverges from a target yaw rate of the corresponding steering input. In addition, the evaluation of the yaw rate also makes it possible, for example, to detect an unexpected operating condition in the rear-wheel steering system.

In some examples, the control device determines the inoperable wheel angle based on the received wheel angle of the steerable rear wheel and/or based on the received yaw rate of the vehicle. Merging the measured values of the detected wheel angle and the detected yaw rate enables increased robustness of the steering control system, as several sources of information are used individually or simultaneously to determine the inoperable wheel angle.

According to a further aspect, the disclosure also relates to a computer program product, comprising instructions which, when executed by a processor, cause the processor to perform at least partially the method described above, in particular the computational, comparison and output operations. The benefits achieved by the process described herein are also achieved in a corresponding manner by the computer program product.

According to an additional aspect, the disclosure also relates to a non-transitory computer-readable storage medium, comprising instructions which, when executed by a processor, cause the computer program product to execute at least partially the method described above, in particular the computational, comparison and output operations. The advantages achieved by the process described herein are also achieved in a corresponding way by the non-transitory computer-readable storage medium.

According to another aspect, the problem is also solved by a SBW steering system for a vehicle. The SBW steering system includes at least a front-wheel steering system, a rear-wheel steering system and a control device coupled with the front-wheel steering system and the rear-wheel steering system. The front-wheel steering system is configured to vary a first wheel angle of a steerable front wheel of the vehicle. The rear-wheel steering system is configured to vary a second wheel angle of a steerable rear wheel of the vehicle. The control device is configured to receive or detect a rear-wheel steering error, receive or determine an inoperable wheel angle of a steerable rear wheel of the vehicle, and trigger a compensatory measure in such a way that a yaw rate of the vehicle around a vehicle vertical axis caused by the inoperable wheel angle of the steerable rear wheel of the vehicle is at least partially compensated, based on an adjusted control signal generated by the control device.

The advantages achieved by the method are also achieved in a corresponding way by the SBW steering system. For example, the SBW steering system enables at least partial compensation for misalignment of a steerable rear wheel for the driver at the steering wheel. For example, the steering wheel may be aligned according to a straight line when the vehicle is driving straight ahead, even though the steerable rear wheel has an inoperable wheel angle compared to the straight position. Appropriate adjustment of the front wheel steering system thus increases comfort for the driver.

According to a further aspect, some examples of the disclosure relate to a vehicle including a SBW steering system as described herein. The benefits achieved by the method described herein are also achieved in a corresponding manner by the vehicle.

For the purposes of disclosure, vehicles may include, in particular, land vehicles, namely, inter alia, off-road and on-road vehicles such as passenger cars, buses, trucks and other commercial vehicles. Vehicles can be manned or unmanned. The vehicles can have an internal combustion engine, alternatively an electric motor to drive them, or they can be hybrid vehicles.

All of the features mentioned below with respect to the examples and/or accompanying figures may be combined, alone or in any sub-combination, with features of the example, including features of preferred examples.

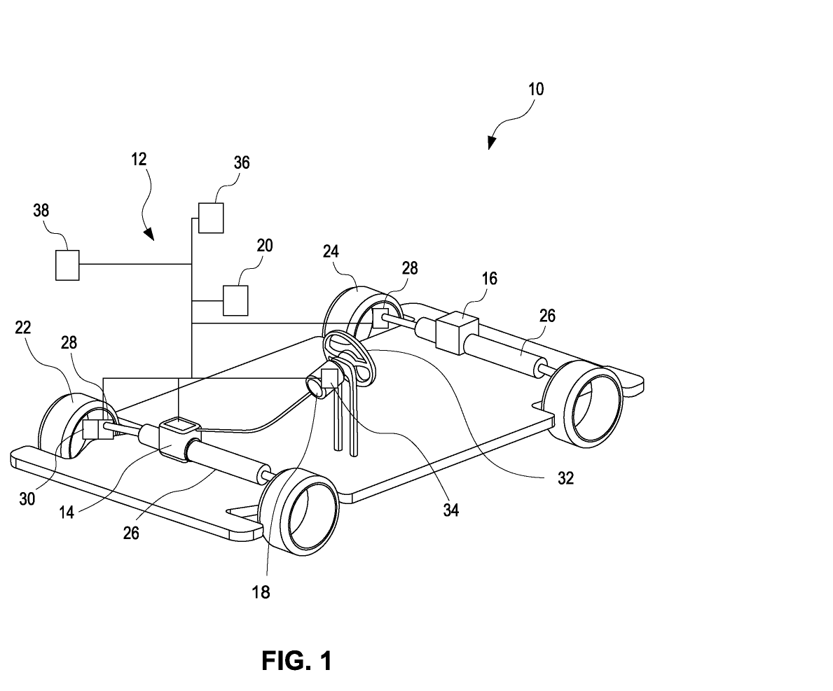

FIG. 1 shows a vehicle 10 including a SBW steering system 12 constructed in accordance with the teachings herein. The SBW steering system 12 includes a front-wheel steering system 14 and a rear-wheel steering system 16. The SBW steering system 12 also includes a hand wheel actuator 18 (e.g., a steering wheel actuator, a feedback actuator (FBA), etc.) and a control device 20. The control device 20 is coupled with the front-wheel steering system 14, the rear-wheel steering system 16, and the hand wheel actuator 18. According to this example, the control device 20 of the SBW steering system 12 is shown as a single component. In general, however, the control device 20 can also be formed by several subcomponents, each of which is assigned separately to the front-wheel steering 14, the rear-wheel steering 16 and the FBA 18, for example.

The front-wheel steering system 14 and the rear-wheel steering system 16 are each indirectly coupled to steerable front wheels 22 and steerable rear wheels 24 of the vehicle 10, respectively. For this purpose, the front-wheel steering system 14 and the rear-wheel steering system 16 each include an electric motor coupled to a respective rack 26. The front-wheel steering system 14 and the rear-wheel steering system 16 can output torque based on the respective electric motor to vary a position of the respective rack 26 along the rack travel.

The respective rack 26 is coupled to the steerable front wheels 22 and the steerable rear wheels 24 of the vehicle 10. The displacement of the rack 26 with respect to a reference position, such as a zero position (e.g., a straight position), leads to a change in the orientation of the steerable front wheels 22 or rear wheels 24 around the respective wheel steering axles. In general, the rack 26 can also be omitted. Then, for example, the front-wheel steering system 14 and the rear-wheel steering system 16 can each include several actuators, each of which is assigned to individual road wheels of the vehicle 10.

The SBW steering system 12 includes road wheel angle sensors 28, each assigned to a single steerable road wheel of the vehicle 10. Each road wheel angle sensor 28 is configured to detect a road wheel steering angle (e.g., a front wheel angle or a rear wheel angle) of the respective steerable front wheel 22 or rear wheel 24 around the respective wheel steering axle and transmit it to the control device 20.

In some examples, instead of a road wheel angle sensor 28, the SBW steering system 12 can also include a rack and pinion sensor that detects a position of a rack 26 against a reference position. Because rack 26 is coupled to the steerable front wheels 22 or the rear wheels 24, a deflection of the rack 26 leads to a rotation of the steerable front wheels 22 or the rear wheels 24 around the respective wheel steering axles. Therefore, the orientation of the steerable front wheels 22 or the rear wheels 24 can be determined from the respective recorded rack and pinion position, in particular by the control device 20 of the SBW steering system 12.

In some examples, instead of the road wheel angle sensor 28, the SBW steering system 12 can also include a pinion sensor associated with a pinion whose position and/or angular position are affected by torque output from the front wheel steering system 14 or the rear wheel steering system 16. The pinion is also at least indirectly coupled to the steerable front wheels 22 or the steerable rear wheels 24. Thus, a change in the position and/or angular position of the pinion can be used to determine a corresponding change in the front wheel angle of the steerable front wheel 22 or a rear wheel angle of the steerable rear wheel 24.

In addition, the vehicle 10 includes a speed sensor 30, which is assigned to at least one road wheel of the vehicle 10. The speed sensor 30 is configured to detect a rotation rate of the assigned road wheel around the axis and transmit it to the control device 20. The control device 20 can determine the vehicle speed of the vehicle 10 based on the received yaw rate. In some examples, several speed sensors 30 can be assigned to different road wheels. In some examples, several sensor units can also form a sensor together, which enables mutual plausibility checks and redundancy.

The SBW steering system 12 also includes a steering wheel 32, with which the hand wheel actuator 18 is coupled at least indirectly, for example via a steering column. The hand wheel actuator 18 is configured to apply feedback torque to the steering wheel 32, giving the driver of the vehicle 10 a sense of lateral guidance of the vehicle 10. The driver of the vehicle 10 can use the steering wheel 32 to make steering instructions for the vehicle 10.

The SBW steering system 12 also includes at least one steering wheel sensor 34 that is configured to detect a steering wheel angle (e.g., a steering wheel position) of the steering wheel 32 in relation to a reference position, such as a center position (e.g., a zero position). Consequently, the steering wheel sensor 34 can be used to detect steering inputs from the driver of the vehicle 10 based on the steering wheel 32. In this respect, a steering input defines a specific current steering wheel angle and steering wheel speed.

The hand wheel actuator 18 includes an electric motor. Using the electric motor, the hand wheel actuator 18 can apply torque to the steering wheel 32 that affects the steering wheel angle and/or steering wheel speed, for example based on a control signal from the control device 20.

A current steering input generally corresponds to a specific current front wheel target angle of the steerable front wheel 22 and a specific current rear wheel target angle of the steerable rear wheel 24, according to which the steerable road wheels are to be aligned. Because the steerable front wheels 22 and the steerable rear wheels 24 are at least indirectly coupled to the respective racks 26 according to this example, a steering input is equivalent to a specific rack position of the respective rack 26, according to which the respective rack 26 is to be moved to achieve a desired orientation of the road wheels.

By changing the steering wheel position, the current steering input is dynamically changed by the driver, which in turn leads to a dynamic change in the rack and pinion position. In addition, based on the orientation of the steerable front wheels 22 and the steerable rear wheels 24 or based on the rack position of the respective rack 26, a feedback torque is determined that is to be generated by the hand wheel actuator 18 on the steering wheel 32. Based on the feedback torque, the driver is given a feeling about the lateral guidance of the vehicle 10.

The dependence of the rack and pinion position on the current steering input in the form of the current steering wheel angle and/or steering wheel speed is considered by the control device 20 within the framework of a steering ratio. The steering ratio thus describes how the front wheel angle of the respective steerable front wheel 22 and/or the rear wheel angle of the respective steerable rear wheel 24 (or the respective rack position of the rack 26) varies dynamically depending on the steering wheel angle and/or the steering wheel speed of the steering wheel 32 and vice versa. In general, the steering ratio is variable (e.g., the steering ratio can have different dependency ratios for different parameter ranges). For example, the respective road wheel angle, especially for small deflections of the steering wheel 32 from the reference position (e.g., the straight alignment), can depend linearly on the respective deflection of the steering wheel 32. For larger deflections of the steering wheel 32 compared to the reference position, a transition to a non-linear dependency ratio can generally be considered.

In some examples, the steering wheel sensor 34 is integrated into the hand wheel actuator 18. However, in other examples, the steering wheel sensor 34 can be separate from the hand wheel actuator 18. The steering wheel sensor 34 is configured to transmit the detected steering wheel angle to the control device 20.

The control device 20 of the SBW steering system 12 is also configured to output appropriate control signals to the front-wheel steering system 14 and/or the rear-wheel steering system 16. To execute the corresponding control routines, the control device 20 can consider other parameters of the vehicle 10, such as the vehicle speed or a yaw rate of the vehicle 10. In some examples, the vehicle 10 includes a yaw rate sensor 36 for detecting the yaw rate, which is configured to detect the yaw rate of the vehicle 10 around a vehicle vertical axis and transmit it to the control device 20.

The respective road wheel angle sensor 28 detects a front wheel angle of the steerable front wheel 22 or the steerable rear wheel 24 and transmits the detected road wheel angle to the control device 20. Considering the steering ratio, the control device 20 determines a corresponding feedback torque which is output to the steering wheel 32. In some examples, instead of the road wheel angle, the rack position of the respective rack 26 can also be detected and considered by a corresponding rack sensor. In addition, the control device 20 of the SBW steering system 12 is coupled with a storage device 38 (e.g., a data memory), in which control parameters and/or vehicle parameters and/or parameter curves for steering ratios are stored. In some examples, the SBW steering system 12 can also include several similar and generally functional components, such as several steering wheel sensors 34, which ensures redundancy.

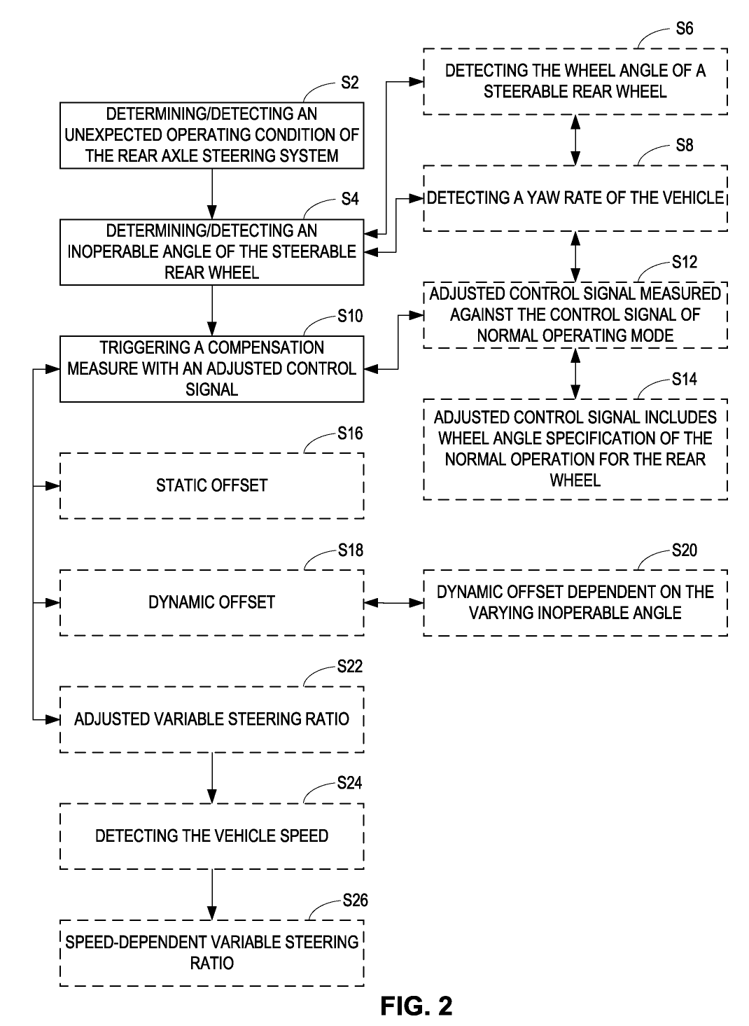

FIG. 2 is a flowchart representative of example machine readable instructions and/or example operations that may be executed, instantiated, and/or performed by example programmable circuitry to implement the SBW steering system of FIG. 1. In operation S2, the control device 20 detects or receives an unexpected operating condition of the rear-wheel steering system 16. For example, this may be due to a breakdown in communication with the rear-wheel steering 16 or incorrect feedback from the rear-wheel steering 16.

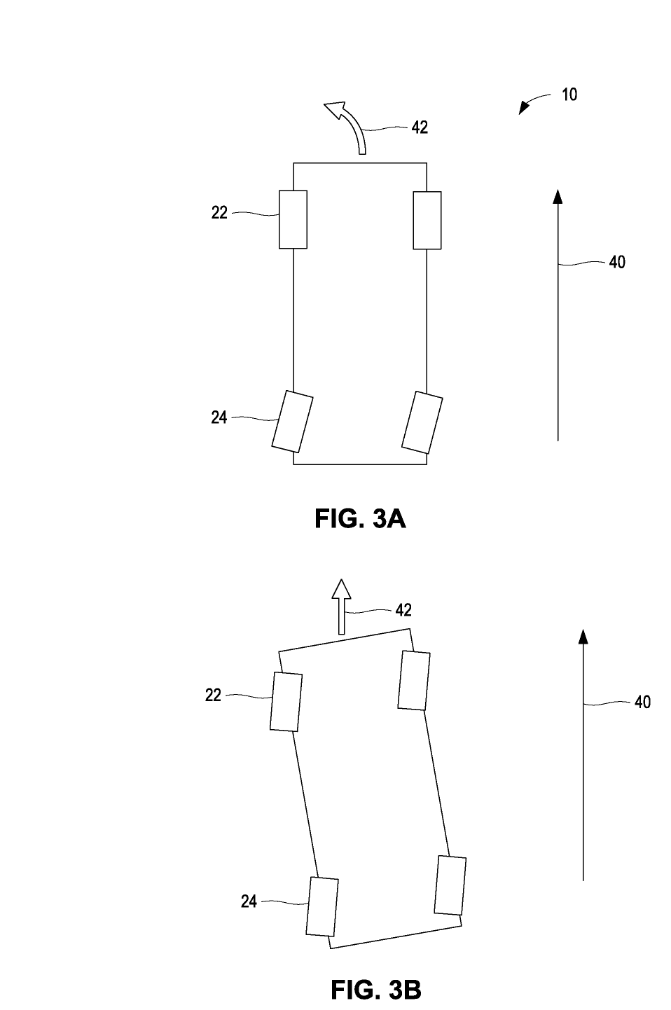

Due to the unexpected operating condition of the rear-wheel steering 16, the orientation of the steerable rear wheel 24 is typically locked. At least it deviates from a target angle for the steerable rear wheel 24, which is based on the steering input on the steering wheel 32. This means that the steerable rear wheel 24 may be deflected, for example, even though the steering input on the steering wheel 32 corresponds to a straight line. In this context, FIG. 3A shows a schematic representation of a vehicle 10 in the course of the method. As an example, it is shown here that the steering input on the steering wheel 32 corresponds to a straight alignment 40. For this reason, the steerable front wheels 22 are oriented parallel to the straight-line alignment 40. However, due to the unexpected operating condition in the rear-wheel steering system 16, the orientation of the steerable rear wheels 24 deviates from the straight-line alignment 40. This causes a yaw rate 42 for the vehicle 10, which causes the vehicle 10 to rotate around the vehicle's vertical axis.

In the subsequent operation S4, the control device 20 determines or receives a inoperable wheel angle of a steerable rear wheel 24 of vehicle 10.

Operation S4 can be further implemented by the optional operation S6. For example, a wheel angle sensor 28 can be used, which is assigned to the steerable rear wheel 24. The wheel angle sensor 28 detects the wheel angle of the steerable rear wheel 24 and transmits it to the control device 20. The control device 20 can compare the detected wheel angle of the steerable rear wheel 24 with the target angle according to the steering input on the steering wheel 32 and thus determine the inoperable wheel angle of the steerable rear wheel 24.

Operation S4 can also be further implemented by the optional operation S8. In such examples, a yaw rate sensor 36 is used to detect the yaw rate (e.g., the yaw moment) of the vehicle 10 around the vehicle's vertical axis and transmit it to the control device 20. Based on the yaw rate, the control device 20 can also determine the inoperable wheel angle of the steerable rear wheel 24 by comparing it with the target angle for the steerable rear wheel 24.

Following operation S4, the method includes operation S10. In operation S10, the control device 20 triggers a compensatory measure in such a way that a yaw rate of vehicle 10 caused by the inoperable wheel angle of the steerable rear wheel 24 of the vehicle 10 is at least partially compensated for. This is achieved by an adapted control signal generated by the control device 20 for the front-wheel steering system 14. The adjusted control signal for the front wheel steering 14 can at least partially compensate for the yaw rate caused by the inoperable wheel angle of the steerable rear wheel 24. This at least mitigates or fully compensates for the effects on the lateral control of the vehicle 10 caused by the inoperable of rear-wheel steering system 16. This increases the comfort for the driver of the vehicle 10, because the lateral guidance of the vehicle 10 corresponds to the lateral guidance of the vehicle 10 during a normal operating condition of the vehicle 10. Operation S10 can be further implemented by the optional operations S12 and S14.

In accordance with the optional operation S12, in the normal mode of the SBW steering system 12, the control device 20 emits 14 a control signal to the front-wheel steering system 14 based on a steering input corresponding to a wheel angle input of at least one steerable front wheel 22. The wheel angle input for the at least one steerable front wheel 22 can be based on the steering input that the driver of the vehicle 10 makes on the steering wheel 32. The control signals for the front-wheel steering system 14 are based on a steering ratio of the normal operating mode. In such examples, the adapted control signal is configured at the control signal of the normal operating mode. This means that the control signal of the normal operating mode of the SBW steering system 12 is used as a reference for the adapted control signal of operation S10.

Based on the steering input on the steering wheel 32 available at the time of control, the control device 20 determines a target angle for the steerable front wheels 22, which is transmitted to the front wheel steering system 14 in the form of a control signal. To mitigate or completely compensate for the yaw rate caused by the inoperable wheel angle of the steerable rear wheel 24, the control signal based on the steering input is adjusted by the control device 20 so that an adjusted control signal corresponding to the compensatory measure is output to the front wheel steering system 14. This means that a different target angle input is issued for at least one steerable front wheel 22 so that the effects of the unexpected operating condition of the rear-wheel steering system 16 are at least partially compensated.

In accordance with the optional operation S14, the control device 20 for the adapted control signal of the front wheel steering system 14 considers a wheel angle input for a steerable rear wheel 24 intended at the time of control in accordance with the steering input on the steering wheel 32. At the respective control time, the control device 20 in the normal operating mode of the SBW steering system 12 determines a target angle for the steerable rear wheel 24 of the rear-wheel steering system 16, considering a steering ratio of the normal operating mode. The corresponding target angle is set based on a control signal issued to the rear-wheel steering system 16. Due to the unexpected operating condition of the rear-wheel steering system 16, the target angle (e.g., the wheel angle input) can no longer be properly considered and set by the rear-wheel steering system 16. In such examples, the adjusted control signal for front-wheel steering system 14 can also be based, at least proportionately, on the wheel angle input of at least one steerable rear wheel 24 determined for this control interval. This ensures similar dynamics regarding the lateral control of the vehicle 10 even in the event of an unexpected operating condition in the rear-wheel steering system 16.

Operation S10 can also be further trained by the optional operations S16, S18 and S22. In accordance with the optional operation S16, the actuator adjusted by the control device 20 for the front-wheel steering system 14 has a static offset for several consecutive control intervals of the control device. The static offset is considered by the control device 20 if the inoperable wheel angle of the steerable rear wheel 24 is static (e.g., constant over several control periods). In some examples, it can be considered that the determined inoperable wheel angle of the steerable rear wheel 24 diverges in a constant (e.g., static) manner compared to the wheel angle input determined for the respective control interval of the control device 20 based on the normal operating mode. This means that there is a constant misalignment of the steerable rear wheel 24.

In accordance with the optional operation S18, the actuator adjusted by the control device 20 for the front-wheel steering system 14 has a dynamically varying offset for several successive control intervals of the control device. The dynamically varying offset is considered if the inoperable wheel angle (e.g., the divergence of the wheel angle detected with respect to the steerable rear wheel 24 relative to the wheel angle input of the respective control interval of the control device 20) changes dynamically. As a result, the unexpected operating condition of rear-wheel steering system 16 can be compensated for at least proportionately, even if it has different effects in terms of time, regardless of the steering input on steering wheel 32.

The optional operation S18 can be further implemented by the optional operation S20, in which the control device 20 receives or determines the inoperable wheel angle of the steerable rear wheel 24 of the rear-wheel steering system 16 for each control interval. As a result, the control device 20 can dynamically form the offset of the adapted control signal for the front-wheel steering system 14 of the vehicle 10 and measure it against the dynamically varying inoperable wheel angle.

Both the static offset and the dynamic offset result in an adapted control signal for the front-wheel steering system 14, which is output by the control device 20. This means that the steerable front wheels 22 of the front-wheel steering system 14 are aligned in such a way that the yaw rate of the vehicle 10 around the vehicle's vertical axis, which is due to the error of the rear-wheel steering system 16, is at least partially compensated.

As an example, this can result in the configuration of the vehicle 10, which is shown in FIG. 3B. Although the driver's steering input on the steering wheel 32 corresponds to the straight line orientation 40, the steerable front wheels 22 are subjected to an adapted control signal by the control device 20, which corresponds to the compensation of the inoperable wheel angle of the steerable rear wheels 24. The yaw rate 42 caused by the misalignment of the steerable rear wheels 24 is therefore compensated by the adjusted control signal, so that the yaw rate is zero and the vehicle 10 is moved according to the straight line orientation 40 despite the front wheels 22 being deflected and the rear wheels 24 being deflected. Although the vehicle body may be twisted in such examples compared to the straight alignment 40, this enables lateral guidance of the vehicle 10 that corresponds to the normal operating mode. For example, the steering wheel 32 is oriented according to the straight alignment 40 (e.g., the middle position), so that there is a natural steering feel for the driver and the comfort is high.

In the optional operation S22, the adjusted control signal for the front-wheel steering system 14 is determined by the control device 20 based on an adapted variable steering ratio of the SBW steering system 12. This means that the control device 20 applies a steering ratio that is alternative to the steering ratio of the normal operating mode. For this purpose, the control device 20 can, for example, read out corresponding parameter curves from the storage device 38. The ratio between the steering input on the steering wheel 32 and the angle input for the steerable front wheel 22 of the front-wheel steering system 14 can be influenced by the adapted variable steering ratio. In a corresponding way, the control device 20 then adjusts the control signal to ensure the compensation of the yaw rate 42. The optional operation S22 can be further implemented by the optional operations S24 and S26.

With regard to the optional operations S16, S18 and S22, the adapted control signal for the front-wheel steering system 14 may be implemented according to the optional operation S12 so that the control device 20 outputs the control signal to the front-wheel steering system 14 in the normal operating state of the SBW steering system 12. This means that the control signal that the control device 20 would output in normal operation can serve as a reference for the adapted control signal according to each of the different configurations.

According to the optional operation S24, the vehicle speed of vehicle 10 is detected and transmitted to the control device 20. For example, the speed sensor 30 can be used for this purpose.

In accordance with the following optional operation S26, an adapted variable steering ratio is then applied by the control device 20, which is configured to be speed-dependent. This enables a high degree of agility in terms of lateral control, especially at low vehicle speeds, and increased vehicle stability at higher speeds.

Example instructions and/or operations of FIG. 2 may be implemented using executable instructions (e.g., computer-readable and/or machine-readable instructions) stored on one or more non-transitory computer-readable and/or machine-readable media. As used herein, the terms non-transitory computer-readable medium, non-transitory computer-readable storage medium, non-transitory machine-readable medium, and/or non-transitory machine-readable storage medium are expressly defined to include any type of computer-readable storage device and/or storage disk and to exclude propagating signals and to exclude transmission media. Examples of such non-transitory computer-readable medium, non-transitory computer-readable storage medium, non-transitory machine-readable medium, and/or non-transitory machine-readable storage medium include optical storage devices, magnetic storage devices, a hard disk drive (HDD), a flash memory, a read-only memory (ROM), a compact disc (CD), a digital versatile disc (DVD), a cache, a random-access memory (RAM) of any type, a register, and/or any other storage device or storage disk in which information is stored for any duration (e.g., for extended time periods, permanently, for brief instances, for temporarily buffering, and/or for caching of the information). As used herein, the terms “non-transitory computer-readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer-readable storage devices and/ or non-transitory machine-readable storage devices include random-access memory of any type, read-only memory of any type, solid-state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer-readable instructions, machine-readable instructions, etc., and/or manufactured to execute computer-readable instructions, machine-readable instructions, etc.

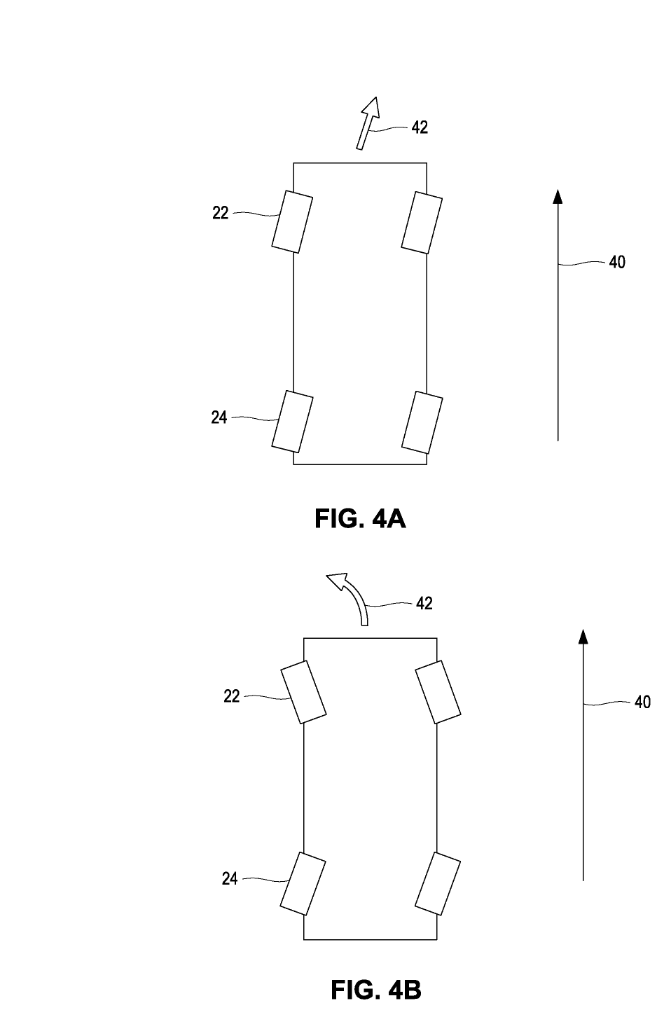

FIGS. 4A and 4B show further schematic representations of a vehicle 10 in the course of the method according to the example. The configuration of the vehicle 10 in FIG. 4A illustrates the orientation of the steerable front wheels 22 as an example of higher vehicle speeds according to an adapted variable steering ratio, for example for speeds greater than a first speed threshold. In such examples, the control signal for the front wheel steering system 14 is adjusted by the control device 20 in such a way that the inoperable wheel angle of the steerable rear wheels 24 is compensated for or at least reduced. As a result, the lateral guidance of vehicle 10 corresponds more precisely to the steering input on the steering wheel 32 according to the straight alignment. In such examples, the driver may have to steer steering wheel 32 from the center position.

The configuration of the vehicle 10 in FIG. 4B exemplifies the orientation of the steerable front wheels 22 for lower vehicle speeds according to an adapted variable steering ratio, for example for speeds less than the first speed threshold. In such examples, the control signal for the front-wheel steering 14 is adjusted by the control device 20 in such a way that the steering input on the steering wheel 32 is considered more directly than in the configuration shown in FIG. 4A. This allows more dynamic lateral guidance to be achieved.

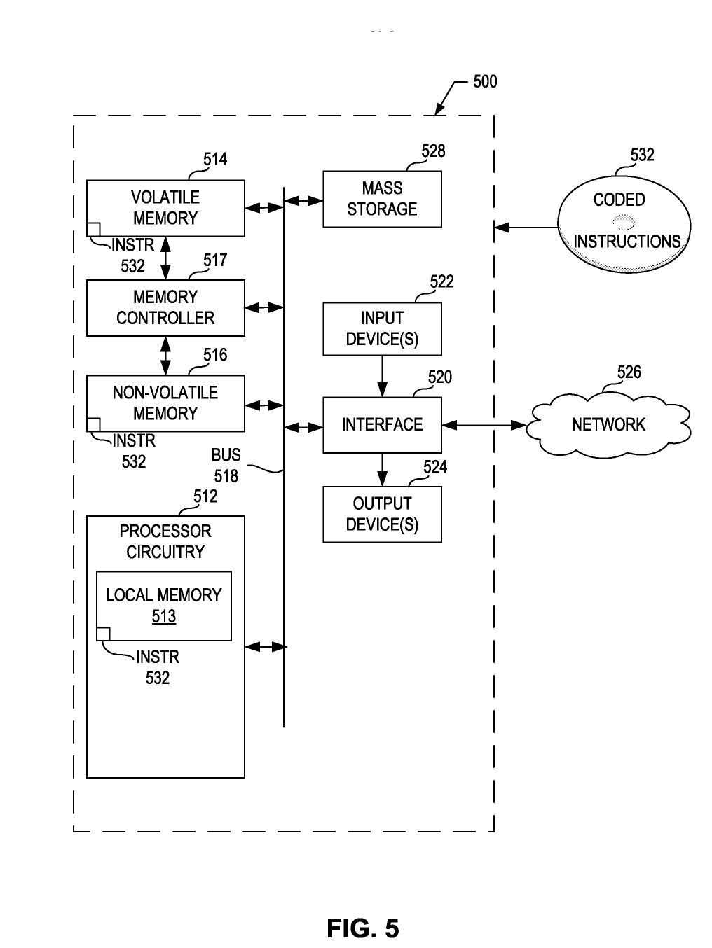

FIG. 5 is a block diagram of an example programmable circuitry platform 500 structured to execute and/or instantiate the example machine-readable instructions and/or the example operations of FIG. [Flowcharts] to implement examples disclosed herein. The programmable circuitry platform 500 can be, for example, a control device, an electronic control unit (ECU), a self-learning machine (e.g., a neural network), or any other type of computing and/or electronic device.

The programmable circuitry platform 500 of the illustrated example includes programmable circuitry 512. The programmable circuitry 512 of the illustrated example is hardware. For example, the programmable circuitry 512 can be implemented by one or more integrated circuits, logic circuits, field programmable gate arrays (FPGAs), microprocessors, central processor units (CPUs), graphics processor units (GPUs), vision processor units (VPUs), digital signal processors (DSPs), and/or microcontrollers from any desired family or manufacturer. The programmable circuitry 512 may be implemented by one or more semiconductor based (e.g., silicon based) devices.

The programmable circuitry 512 of the illustrated example includes a local memory 513 (e.g., a cache, registers, etc.). The programmable circuitry 512 of the illustrated example is in communication with main memory 514, 516, which includes a volatile memory 514 and a non-volatile memory 516, by a bus 518. The volatile memory 514 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 516 may be implemented by flash memory and/or any other desired type of memory device. Access to the main memory 514, 516 of the illustrated example is controlled by a memory controller 517. In some examples, the memory controller 517 may be implemented by one or more integrated circuits, logic circuits, microcontrollers from any desired family or manufacturer, or any other type of circuitry to manage the flow of data going to and from the main memory 514, 516.

The programmable circuitry platform 500 of the illustrated example also includes interface circuitry 520. The interface circuitry 520 may be implemented by hardware in accordance with any type of interface standard, such as a controller area network (CAN), an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 522 are connected to the interface circuitry 520. The input device(s) 522 permit(s) a user (e.g., a human user, a machine user, etc.) to enter data and/or commands into the programmable circuitry 512. The input device(s) 522 can be implemented by, for example, an audio sensor, a microphone, a camera (still or video), a button, a touchscreen, and/or a voice recognition system.

One or more output devices 524 are also connected to the interface circuitry 520 of the illustrated example. The output device(s) 524 can be implemented, for example, by display devices (e.g., a light emitting diode (LED), an organic light emitting diode (OLED), a liquid crystal display (LCD), an in-place switching (IPS) display, a touchscreen, etc.), a tactile output device, and/or speaker. The interface circuitry 520 of the illustrated example, thus, typically includes a graphics driver card, a graphics driver chip, and/or graphics processor circuitry such as a GPU.

The interface circuitry 520 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 526. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 500 of the illustrated example also includes one or more mass storage discs or devices 528 to store firmware, software, and/or data. Examples of such mass storage discs or devices 528 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or solid-state drives (SSDs).

The machine-readable instructions 532, which may be implemented by the machine-readable instructions of FIG. 2, may be stored in the mass storage device 528, in the volatile memory 514, in the non-volatile memory 516, and/or on at least one non-transitory computer readable storage medium such as a CD or DVD which may be removable.

From the foregoing, it will be appreciated that example systems, apparatus, articles of manufacture, and methods have been disclosed that enable SBW steering systems. Further examples and combinations thereof include the following:

Example 1 includes a steer-by-wire (SBW) steering system comprising a front-wheel steering system, a rear-wheel steering system, and a controller configurable to detect an unexpected operating condition of the rear-wheel steering system, determine a wheel angle associated with the unexpected operating condition, and generate a control signal to cause a road wheel actuator of the front-wheel steering system to steer road wheels coupled to the front-wheel steering system based on the unexpected operating condition and the wheel angle.

Example 2 includes the SBW steering system of any preceding clause, wherein the control signal includes a dynamic offset which is varied by the controller based on the wheel angle.

Example 3 includes the SBW steering system of any preceding clause, wherein the controller is configured to adjust a steering ratio associated with the SBW steering system based on the unexpected operating condition and the wheel angle.

Example 4 includes the SBW steering system of any preceding clause, wherein the controller is configured to adjust the steering ratio further based on a speed associated with a vehicle.

Example 5 includes the SBW steering system of any preceding clause, wherein the controller is configured to increase the steering ratio when the speed is above a first threshold and decrease the steering ratio when the speed is below the first threshold.

Example 6 includes the SBW steering system of any preceding clause, wherein the control signal is further based on a position of a steering wheel associated with the SBW steering system and a desired road wheel position associated with the rear-wheel steering system.

Example 7 includes the SBW steering system of any preceding clause, wherein the controller is configured to determine the wheel angle based on a yaw rate associated with a vehicle.

Example 8 includes a vehicle comprising a steer-by-wire (SBW) steering system including a front-wheel steering system and a rear-wheel steering system, first road wheels coupled to the front-wheel steering system and second road wheels coupled to the rear-wheel steering system, and controller circuitry to execute machine readable instructions to detect an unexpected operating condition of the rear-wheel steering system, determine a wheel angle of the second road wheels associated with the unexpected operating condition, and generate a control signal to cause the front-wheel steering system to steer the first road wheels based on the unexpected operating condition and the wheel angle.

Example 9 includes the vehicle of any preceding clause, wherein the control signal includes a dynamic offset which is varied by the controller circuitry based on the wheel angle.

Example 10 includes the vehicle of any preceding clause, wherein the controller circuitry is to adjust a steering ratio associated with the SBW steering system based on the unexpected operating condition and the wheel angle.

Example 11 includes the vehicle of any preceding clause, wherein the controller circuitry is to adjust the steering ratio further based on a speed associated with the vehicle.

Example 12 includes the vehicle of any preceding clause, wherein the controller circuitry is to increase the steering ratio when the speed is above a first threshold and decrease the steering ratio when the speed is below the first threshold.

Example 13 includes the vehicle of any preceding clause, wherein the control signal is further based on a position of a steering wheel of the vehicle and a desired position of the second road wheels.

Example 14 includes the vehicle of any preceding clause, wherein the controller circuitry is to determine the wheel angle based on a yaw rate associated with the vehicle.

Example 15 includes a non-transitory computer readable storage medium comprising instructions to cause at least one programmable circuitry to detect an unexpected operating condition of a rear-wheel steering system, determine a wheel angle associated with the unexpected operating condition, and generate a control signal to cause a front-wheel steering system to steer road wheels coupled to the front-wheel steering system based on the unexpected operating condition and the wheel angle.

Example 16 includes the non-transitory computer readable storage medium of any preceding clause, wherein the control signal includes a dynamic offset which is varied by the at least one programmable circuitry based on the wheel angle.

Example 17 includes the non-transitory computer readable storage medium of any preceding clause, wherein the at least one programmable circuitry is to adjust a steering ratio associated with a steer-by-wire (SBW) steering system based on the unexpected operating condition and the wheel angle.

Example 18 includes the non-transitory computer readable storage medium of any preceding clause, wherein the at least one programmable circuitry is to adjust the steering ratio further based on a speed associated with a vehicle.

Example 19 includes the non-transitory computer readable storage medium of any preceding clause, wherein the control signal is further based on a position of a steering wheel associated with a steer-by-wire (SBW) steering system and a desired road wheel position associated with the rear-wheel steering system.

Example 20 includes the non-transitory computer readable storage medium of any preceding clause, wherein the at least one programmable circuitry is to determine the wheel angle based on a yaw rate associated with a vehicle.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. A steer-by-wire (SBW) steering system comprising:
a front-wheel steering system;
a rear-wheel steering system; and
a controller configurable to:
detect an unexpected operating condition of the rear-wheel steering system;
determine a wheel angle associated with the unexpected operating condition; and
generate a control signal to cause a road wheel actuator of the front-wheel steering system to steer road wheels coupled to the front-wheel steering system based on the unexpected operating condition and the wheel angle.

2. The SBW steering system of claim 1, wherein the control signal includes a dynamic offset which is varied by the controller based on the wheel angle.

3. The SBW steering system of claim 1, wherein the controller is configured to adjust a steering ratio associated with the SBW steering system based on the unexpected operating condition and the wheel angle.

4. The SBW steering system of claim 3, wherein the controller is configured to adjust the steering ratio further based on a speed associated with a vehicle.

5. The SBW steering system of claim 4, wherein the controller is configured to increase the steering ratio when the speed is above a first threshold and decrease the steering ratio when the speed is below the first threshold.

6. The SBW steering system of claim 1, wherein the control signal is further based on a position of a steering wheel associated with the SBW steering system and a desired road wheel position associated with the rear-wheel steering system.

7. The SBW steering system of claim 1, wherein the controller is configured to determine the wheel angle based on a yaw rate associated with a vehicle.

8. A vehicle comprising:
a steer-by-wire (SBW) steering system including a front-wheel steering system and a rear-wheel steering system;
first road wheels coupled to the front-wheel steering system and second road wheels coupled to the rear-wheel steering system; and
controller circuitry to execute machine readable instructions to:
detect an unexpected operating condition of the rear-wheel steering system;
determine a wheel angle of the second road wheels associated with the unexpected operating condition; and
generate a control signal to cause the front-wheel steering system to steer the first road wheels based on the unexpected operating condition and the wheel angle.

9. The vehicle of claim 8, wherein the control signal includes a dynamic offset which is varied by the controller circuitry based on the wheel angle.

10. The vehicle of claim 8, wherein the controller circuitry is to adjust a steering ratio associated with the SBW steering system based on the unexpected operating condition and the wheel angle.

11. The vehicle of claim 10, wherein the controller circuitry is to adjust the steering ratio further based on a speed associated with the vehicle.

12. The vehicle of claim 11, wherein the controller circuitry is to increase the steering ratio when the speed is above a first threshold and decrease the steering ratio when the speed is below the first threshold.

13. The vehicle of claim 8, wherein the control signal is further based on a position of a steering wheel of the vehicle and a desired position of the second road wheels.

14. The vehicle of claim 8, wherein the controller circuitry is to determine the wheel angle based on a yaw rate associated with the vehicle.

15. A non-transitory computer readable storage medium comprising instructions to cause at least one programmable circuitry to:
detect an unexpected operating condition of a rear-wheel steering system;
determine a wheel angle associated with the unexpected operating condition; and
generate a control signal to cause a front-wheel steering system to steer road wheels coupled to the front-wheel steering system based on the unexpected operating condition and the wheel angle.

16. The non-transitory computer readable storage medium of claim 15, wherein the control signal includes a dynamic offset which is varied by the at least one programmable circuitry based on the wheel angle.

17. The non-transitory computer readable storage medium of claim 15, wherein the at least one programmable circuitry is to adjust a steering ratio associated with a steer-by-wire (SBW) steering system based on the unexpected operating condition and the wheel angle.

18. The non-transitory computer readable storage medium of claim 17, wherein the at least one programmable circuitry is to adjust the steering ratio further based on a speed associated with a vehicle.

19. The non-transitory computer readable storage medium of claim 15, wherein the control signal is further based on a position of a steering wheel associated with a steer-by-wire (SBW) steering system and a desired road wheel position associated with the rear-wheel steering system.

20. The non-transitory computer readable storage medium of claim 15, wherein the at least one programmable circuitry is to determine the wheel angle based on a yaw rate associated with a vehicle.
